(19) United States
(12) Patent Application Publication
(10) Pub. No.: US 2008/0250908 A1
(43) Pub. Date: Oct. 16, 2008

(54) Bag Making Machine

(75) Inventor: Mikio Totani, Kyoto (JP)

Correspondence Address: KIRSCHSTEIN, OTTINGER, ISRAEL;& SCHIFFMILLER, P.C., 425 FIFTH AVENUE, 5TH FLOOR, NEW YORK, NY, 10016-2223, US

(73) Assignee: TOTANI CORPORATION, Kyoto-shi, Kyoto (JP)

(21) Appl. No.: 11/630,875

(22) PCT Filed: Dec. 20, 2004
(86) PCT No.: PCT/JP2004/019013

§ 371 Date: Feb. 21, 2008

(30) Foreign Application Priority Data
Jun. 23, 2004 (JP) 2004-185153
Jul. 7, 2004 (JP) 2004-200403

(51) Int. Cl. B26D 5/20

(52) U.S. Cl. 83/76

(57) ABSTRACT

A bag making machine for producing plastic bags by processing plastic films by a processing device, wherein it is intended to accurately process plastic films, to protect the processing device from damage, and to save the required time while decreasing the processing rate as little as possible. A driving mechanism is connected to a processing device to drive the latter. Further, a control device is connected to the driving mechanism. After acceleration (α1) of the driving mechanism, the mechanism is once decelerated (β1). At the start of the processing of plastic films, the processing device is driven at a low speed (V2). Further, as the processing proceeds, the driving mechanism is reaccelerated (α2) to drive the processing device at a high speed (V3).

### TECHNICAL FIELD

The invention relates to an apparatus for successively making plastic bags.

### BACKGROUND

The apparatus includes processing means, as a necessity. The apparatus further includes drive means connected to the processing means so that the processing means can be driven and actuated by the drive means. As a result, plastic film means is processed by the processing means to successively make plastic bags.

For example, the plastic film means comprises two superposed layers of plastic film while the processing means comprises a cutter by which the layers of plastic film are cut. The drive means is connected to the cutter. In addition, the layers of plastic film are fed intermittently and longitudinally thereof. The cutter is driven and actuated by the drive means whenever the layers of plastic film are fed intermittently. In general, the cutter comprises a shear including upper and lower blades. The drive means is connected to the upper blade. The upper blade is driven and lowered by the drive means to intersect with the lower blade and come into contact with the layers of plastic film whenever the layers of plastic film are fed intermittently so that the layers of plastic film can be cut by the upper and lower blades after being heat sealed. The layers of plastic film are cut progressively and widthwise thereof. The apparatus can therefore successively make plastic bags.

By the way, it is recently requested to remarkably speed up the apparatus. In this connection, the apparatus is problematic in the upper blade of cutter. In order to remarkably speed up the apparatus, the drive means has to be accelerated at a high acceleration to make the upper blade driven and lowered so that the layers of plastic film can be cut quickly. However, the layers of plastic film have a considerable high strength especially when comprising layers of laminated film. The layers of plastic film can therefore not be cut appropriately if the drive means is accelerated at the high acceleration by reason that the upper blade is lowered at a considerable high speed to come into contact with the layers of plastic film and then bound due to an impact when the layers of plastic film start to be cut. The upper and lower blades may be damaged by the impact.

In addition, in the cutter of the apparatus, in general, the upper blade comes into contact with the lower blade before the layers of plastic film start to be cut. This may make the upper blade bound due to an impact so that the layers of plastic film cannot be cut appropriately. The upper and lower blades may be damaged by the impact.

In order to overcome the problem, the drive means should be accelerated and then decelerated by control means so that the upper blade can be lowered at a relatively low speed to come into contact with the lower blade before the layers of plastic film start to be cut. In addition, the upper blade should be lowered at the relatively low speed to come into contact with the layers of plastic film when the layers of plastic film start to be cut. As to this system, the like has been known as disclosed in Japanese Laid-Open Patent Publication No. 2003-300351. The publication relates to a cutter by which a continuous paper is cut in a printer. The cutter comprises a shear including movable and fixed blades. The movable blade is driven and actuated by drive means. The drive means is accelerated and then decelerated by control means so that the movable blade can be moved at a relatively low speed to come into contact with the paper when the paper starts to be cut. The paper is then cut by the movable and fixed blades.

However, in the cutter of the apparatus for successively making plastic bags, it follows that the cut speed is lowered, taking time, if the drive means is accelerated and then decelerated by control means so that the upper blade can be lowered at a relatively low speed. This affects the bag making speed of the apparatus. It is therefore impracticable to remarkably speed up the apparatus. An improvement is desired.

The cutter may include a Thomson blade, as disclosed in Japanese Laid-Open Patent Publication No. 2004-160780. In the cutter of the publication, drive means is connected to the Thomson blade. The Thomson blade is driven and actuated by the drive means whenever the layers of plastic film are fed intermittently so that the layers of plastic film can be cut by the Thomson blade.

In this case, in order to make the layers of plastic film cut appropriately, the drive means should be accelerated and then decelerated by control means so that the Thomson blade can be driven and actuated at a relatively low speed to come into contact with the layers of plastic film when the layers of plastic film start to be cut. However, the cut speed is lowered, taking time. This affects the bag making speed of the apparatus. It is therefore impracticable to remarkably speed up the apparatus.

In addition, in an apparatus for successively making plastic bags disclosed in Japanese Laid-Open Patent Publications No. 2001-158056 and No. 2003-311853, the plastic bag comprises a flat bottom plastic bag including side gusset portions and a bottom gusset portion incorporated into two superposed layers of panel portion. In the apparatus of the publications, two superposed layers of plastic film are fed intermittently and longitudinally thereof. Drive means is connected to a spatula or movable plate. The spatula or movable plate is driven and moved by the drive means whenever the layers of plastic film are fed intermittently so that the spatula or movable plate can come into contact with a sheet of plastic film to make the sheet of plastic film folded. The sheet of plastic film is then inserted between the layers of plastic film. The bottom gusset portion is formed from the sheet of plastic film and incorporated into the layers of panel portion which are formed from the layers of plastic film. The spatula or movable plate is therefore the processing means.

In this case, in order to make the sheet of plastic film folded appropriately, the drive means should be accelerated and then decelerated by control means so that the spatula or movable plate can be driven and moved at a relatively low speed to come into contact with the sheet of plastic film when the sheet of plastic film starts to be folded. However, the folded speed is lowered, taking time.

Furthermore, in the apparatus including the movable plate, drive means is connected to finger means. The finger means is driven and moved by the drive means whenever the layers of plastic film are fed intermittently so that the finger means can come into contact with the sheet of plastic film which is folded. The sheet of plastic film is thrust by the finger means to be inserted between the layers of plastic film. The finger means is therefore the processing means.

In this case, in order to make the sheet of plastic film thrust and inserted appropriately, the drive means should be accelerated and then decelerated by control means so that the finger means can be driven and moved at a relatively low speed to come into contact with the sheet of plastic film when the sheet of plastic film starts to be inserted. However, the inserted speed is lowered, taking time.

It is therefore an object of the invention to provide an apparatus including processing means by which plastic film means is processed to successively make plastic bags, so as to make the plastic film means processed appropriately, prevent the processing means from being damaged and keep the processed speed from being lowered without taking time.

### SUMMARY OF THE INVENTION

According to the invention, drive means is connected to the processing means so that the processing means can be driven and actuated by the drive means. In addition, control means is connected to the drive means. The drive means is accelerated and then decelerated by the control means so that the processing means can be driven and actuated at a relatively low speed when the plastic film means starts to be processed. The drive means is then accelerated again by the control means so that the processing means can be driven and actuated at a relatively high speed when the plastic film means is being processed.

The drive means may comprise a servomotor.

The processing means may be driven and actuated along a predetermined positional characteristic curve.

The control means may be arranged to recognize if a difference occurs between the real position of processing means and the positional characteristic curve in accordance with a signal transmitted from the servomotor and make the servomotor reversed or free of torque when the difference occurs.

In a preferred embodiment, the processing means comprises a cutter by which the plastic film means is cut. The drive means is connected to the cutter. The plastic film means is fed intermittently and longitudinally thereof. The cutter is driven and actuated by the drive means so that the plastic film means can be cut progressively and widthwise thereof whenever being fed intermittently.

The cutter comprises a shear including upper and lower blades. The drive means is connected to the upper blade. The plastic film means is directed between the upper and lower blades. The upper blade is driven and lowered by the drive means to intersect with the lower blade and come into contact with the plastic film means whenever the plastic film means is fed intermittently so that the plastic film means can be cut by the upper and lower blades.

The upper blade is lowered at the relatively low speed to come into contact with the plastic film means when the plastic film means starts to be cut. The upper blade is then lowered at the relatively high speed when the plastic film means is being cut.

In addition, the upper blade is lowered at the relatively low speed to come into contact with the lower blade before the plastic film means starts to be cut. The upper blade is then lowered at the relatively low speed until the plastic film means starts to be cut.

In another embodiment, the cutter includes a Thomson blade. The drive means is connected to the Thomson blade. The Thomson blade is driven and moved by the drive means whenever the plastic film means is fed intermittently so that the plastic film means can be cut by the Thomson blade.

In another embodiment, the plastic bag comprises a flat bottom plastic bag including side gusset portions and a bottom gusset portion incorporated into two superposed layers of panel portion. Two superposed layers of plastic film are fed intermittently and longitudinally thereof. The plastic film means comprises a sheet of plastic film while the processing means comprises a spatula or movable plate by which the sheet of plastic film is folded. The drive means is connected to the spatula or movable plate. The spatula or movable plate is driven and moved by the drive means whenever the layers of plastic film are fed intermittently so that the spatula or movable plate can come into contact with the sheet of plastic film to make the sheet of plastic film folded. The sheet of plastic film is then inserted between the layers of plastic film. The bottom gusset portion is formed from the sheet of plastic film and incorporated into the layers of panel portion which are formed from the layers of plastic film.

In the embodiment, the processing means may comprise finger means by which the sheet of plastic film is thrust after being folded. The drive means is connected to the finger means. The finger means is driven and moved by the drive means whenever the layers of plastic film are fed intermittently so that the finger means can come into contact with the sheet of plastic film which is folded. The sheet of plastic film is thrust by the finger means to be inserted between the layers of plastic film.

### BRIEF DESCRIPTION OF THE DRAWINGS

FIG. 1 is a side view of a preferred embodiment of the invention.

FIG. 2 is a plan view of the plastic film in the apparatus of FIG. 1.

FIG. 3 is a perspective view of the upper and lower blades of the apparatus of FIG. 1.

FIG. 4 is an explanatory view of the upper blade coming into contact with the lower blade of FIG. 3.

FIG. 5 is an explanatory view of the upper blade coming into contact with the layers of plastic film of FIG. 4.

FIG. 6 is an explanatory view of the upper and lower blades when the layers of plastic film are cut totally of FIG. 5.

FIG. 7 is a graph showing the position and speed of the upper blade of FIG. 1.

FIG. 8 is a perspective view of another embodiment.

FIG. 9 is a side view of another embodiment.

FIG. 10 is a side view of another embodiment.

FIG. 11 is a plan view of another embodiment.

FIG. 12 is an elevational view of the finger means and the guide plates of the apparatus of FIG. 11.

FIG. 13 is a side view of the layers of plastic film and the sheet of plastic film of FIG. 12.

### BEST MODE FOR CARRY OUT THE INVENTION

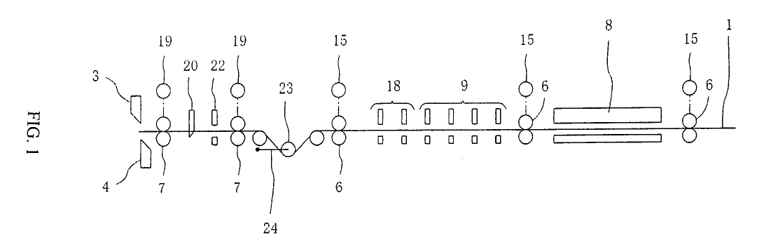

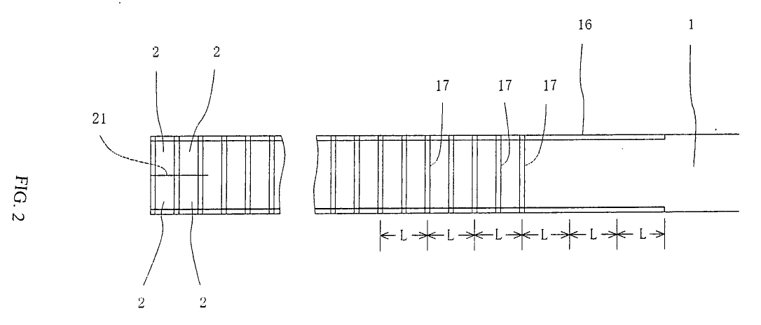

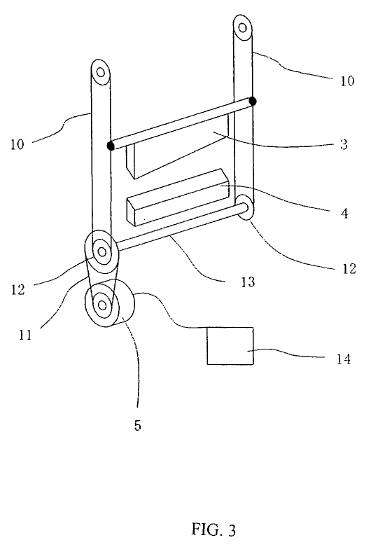

Turning now to the drawings, FIG. 1 illustrates an apparatus for successively making plastic bags according to the invention. The apparatus includes processing means by which plastic film means 1 is processed to successively make plastic bags 2, as shown in FIG. 2. The plastic film means 1 comprises two superposed layers of plastic film while the processing means comprises a cutter by which the layers of plastic film 1 are cut. The cutter comprises a shear including upper and lower blades 3 and 4. The apparatus further includes drive means 5 connected to the cutter, as shown in FIG. 3. The drive means 5 comprises a servomotor.

The layers of plastic film 1 are fed intermittently and longitudinally thereof. In the embodiment, the layers of plastic film 1 are directed to and fed by upstream and downstream feeding rollers 6 and 7. In addition, the layers of plastic film 1 are heat sealed with each other by longitudinal and cross seal means 8 and 9 whenever being fed intermittently. The cutter is driven and actuated by the servomotor 5 so that the layers of plastic film 1 can be cut progressively and widthwise thereof whenever being fed intermittently and after being heat sealed.

The cutter includes the upper and lower blades 3 and 4, as described above. The upper blade 3 is opposed to and disposed on the upper side of the lower blade 4 and mounted on and supported by a pair of timing belts 10. One of the timing belts 10 is engaged with a pulley 12 to which the servomotor 5 is connected by means of a chain or belt 11. The other timing belt 10 is engaged with a pulley 12. A connecting shaft 13 is disposed between the pulleys 12 so that the pulleys 12 can be connected to each other by means of the connecting shaft 13. The servomotor 5 can therefore make the upper blade 3 lowered and raised. The timing belts 10 are synchronized with each other by means of the connecting shaft 13.

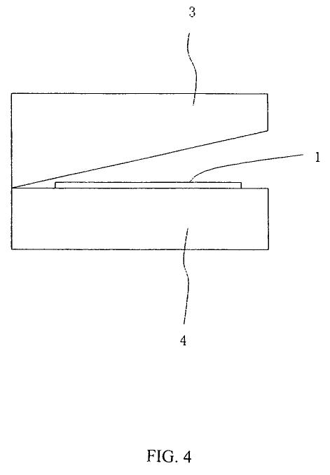

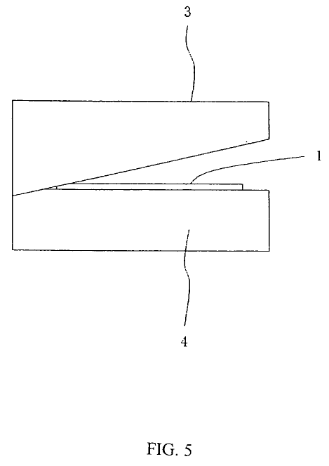

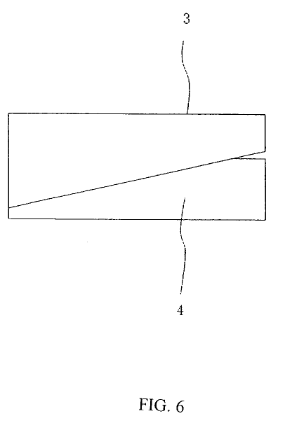

The upper and lower blades 3 and 4 extend widthwise of the layers of plastic film 1. In addition, the lower blade 4 extends horizontally while the upper blade 3 is disposed obliquely. The layers of plastic film 1 are directed between the upper and lower blades 3 and 4. The upper blade 3 therefore comes into contact with the lower blade 4 when being lowered by the servomotor 5, as shown in FIG. 4. The upper blade 3 then intersects with the lower blade 4 and comes into contact with the layers of plastic film 1 so that the layers of plastic film 1 can be cut by the upper and lower blades 3 and 4, as shown in FIG. 5. The cutter can therefore make the layers of plastic film 1 cut progressively and widthwise thereof. The layers of plastic film 1 are then cut totally, as shown in FIG. 6.

Furthermore, the apparatus include a control means 14 connected to the servomotor 5. The servomotor 5 is controlled by the control means 14, as described later in detail. The control means 14 comprises a computer.

The apparatus is called a double speed apparatus. The apparatus includes servomotors 15 controlled by the control means 14. The upstream feeding rollers 6 are driven and actuated by the servomotors 15 so that the layers of plastic film 1 can be fed intermittently along an upstream feeding path for a length which is N times as much as the size of plastic bag 2 and at a cycle number. In addition, the layers of plastic film 1 are heat sealed whenever being fed intermittently to obtain N times in number of plastic bags 2. It should herein be understood that N is an integer equal to or greater than 2. The cycle number means what times the layers of plastic film 1 are fed intermittently per minute.

For example, the layers of plastic film 1 are fed intermittently along the upstream path for a length L which is two times as much as the size of plastic bag 2 and at a cycle number. The longitudinal seal means 8 has a length which is four times as much as the size of plastic bag 2. The longitudinal seal means 8 is driven and actuated by drive means whenever the layers of plastic film 1 are fed intermittently. The layers of plastic film 1 are therefore heat sealed longitudinally thereof by the longitudinal seal means 8 whenever being fed intermittently so that longitudinal sealed portions 16 can be formed on the layers of plastic film 1. The longitudinal seal means 8 is then driven and actuated again whenever the layers of plastic film 1 are fed intermittently so that the layers of plastic film 1 can be heat sealed longitudinally thereof again. In addition, the cross seal means 9 comprises four seal means spaced from each other at a distance corresponding to the size of plastic bag 2. The cross seal means 9 is driven and actuated by the drive means whenever the layers of plastic film 1 are fed intermittently. The layers of plastic film 1 are therefore heat sealed crossly thereof by the cross seal means 9 whenever being fed intermittently so that cross sealed portions 17 can be formed on the layers of plastic film 1. The cross seal means 9 is then driven and actuated again whenever the layers of plastic film 1 are fed intermittently so that the layers of plastic film 1 can be heat sealed crossly thereof again. It should therefore be noted that the layers of plastic film 1 are heat sealed longitudinally thereof twice and heat sealed crossly thereof twice to obtain two times in number of plastic bags 2. In addition, two cooling means 18 are spaced from each other at a distance corresponding to the size of plastic bag 2. The cross sealed portions 17 are cooled by the cooling means 18 whenever the layers of plastic film 1 are fed intermittently.

Furthermore, the apparatus includes servomotors 19 controlled by the control means 14. The downstream feeding rollers 7 are driven and actuated by the servomotors 19 so that the layers of plastic film 1 can be fed intermittently along a downstream feeding path for a length corresponding to the size of plastic bag 2 and at a cycle number which is N times as many as the cycle number of the upstream feeding rollers 6, after being heat sealed and cooled. For example, in the embodiment, the layers of plastic film 1 are fed intermittently along the upstream feeding path for the length which is two times as much as the size of plastic bag 2 and at the cycle number, as described earlier. The layers of plastic film 1 are therefore fed intermittently along the downstream feeding path for the length corresponding to the size of plastic bag 2 and at a cycle number which is two times as many as the cycle number of the upstream feeding rollers 6.

The apparatus further includes a slitter 20 disposed in the downstream feeding path. The layers of plastic film 1 are slit by the slitter 20 along a slit line 21 when being fed intermittently. The layers of plastic film 1 are then cut by the upper and lower blades 3 and 4 whenever being fed intermittently to successively make plastic bags 2 two by two. In addition, the layers of plastic film 1 may be punched out by punch means 22 whenever being fed intermittently so that the plastic bag 2 can be cut at corners. The punch means 22 is called corner cut means. The apparatus may utilize punch means disposed in the downstream feeding path as notch means to make the layers of plastic film 1 punched out so that notches can be formed in the layers of plastic film 1.

The apparatus further includes an accumulator disposed between the upstream and downstream feeding paths. The accumulator comprises a dancer roller 23 supported by an arm 24 and engaged with the layers of plastic film 1. The dancer roller 23 swings downward along with the arm 24 so that the layers of plastic film 1 can be accumulated temporarily by the dancer roller 23 whenever being fed intermittently by the upstream feeding rollers 6. The dancer roller 23 then swings upward along with the arm 24 so that the layers of plastic film 1 can be supplied from the dancer roller 23 whenever being fed intermittently by the downstream feeding rollers 7.

Accordingly, in the apparatus, the layers of plastic film 1 can be heat sealed for N times in number of plastic bags 2 at a time by making the heat seal means 8 and 9 actuated once and making the layers of plastic film 1 heated and pressurized in a considerable seal time. For example, the layers of plastic film 1 can be heat sealed for two times in number of plastic bags 2 at a time. The layers of plastic film 1 are then fed intermittently by the downstream feeding rollers 7 at the cycle number which is N times or two times as many as the cycle number of the upstream feeding rollers 6.

The arrangement can therefore remarkably speed up the apparatus. However, the apparatus is problematic in the upper blade 3 of cutter. In order to remarkably speed up the apparatus, the servomotor 5 has to be accelerated at a high acceleration to make the upper blade 3 driven and lowered so that the layers of plastic film 1 can be cut quickly. In addition, it is required to make the upper blade 3 come into contact with the layers of plastic film 1 without bouncing due to an impact when the layers of plastic film 1 start to be cut so that the layers of plastic film 1 can be cut appropriately, and prevent the upper and lower blades 3 and 4 from being damaged by the impact. It is also required to make the upper blade 3 come into contact with the lower blade 4 without bouncing due to an impact before the layers of plastic film 1 start to be cut so that the layers of plastic film 1 can be cut appropriately, and prevent the upper and lower blades 3 and 4 from being damaged by the impact. Furthermore, it is required to keep the cut speed from being lowered without taking time.

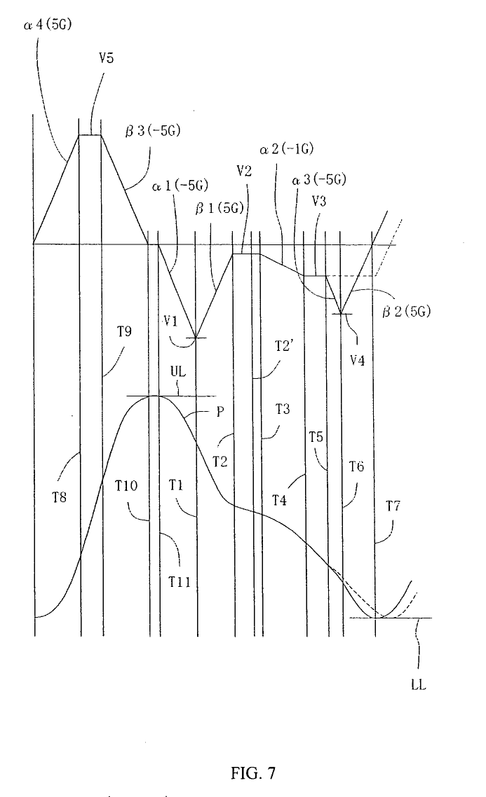

Under the circumstances, in the apparatus, the servomotor 5 is controlled by the control means 14 so that the upper blade 3 can be driven, lowered and raised to be changed in position P, as shown in FIG. 7. In the first place, the upper blade 3 is lowered from an upper limit UL. The servomotor 5 is accelerated by the control means 14 so that the upper blade 3 can be accelerated by the servomotor 5 when being lowered. The upper blade 3 is accelerated at an acceleration a 1 which is the maximum acceleration (−5 G), to be lowered at a speed which reaches the maximum speed V1.

The servomotor 5 is then decelerated by the control means 14 to make the upper blade 3 decelerated at a point after a time from being accelerated (T1). The upper blade 3 is decelerated at a deceleration β1 which is the maximum deceleration (5 G). The upper blade 3 then intersects with the lower blade 4 and comes into contact with the layers of plastic film 1 so that the layers of plastic film 1 can be cut by the upper and lower blades 3 and 4.

Accordingly, the upper blade 3 is lowered at a relatively low speed V2 to come into contact with the layers of plastic film 1 when the layers of plastic film 1 start to be cut (T2′). The layers of plastic film 1 are then cut by the upper and lower blades 3 and 4. The upper blade 3 therefore comes into contact with the layers of plastic film 1 without bouncing due to an impact to make the layers of plastic film 1 cut appropriately. The upper and lower blades 3 and 4 are not damaged by the impact.

In addition, the upper blade 3 comes into contact with the lower blade 4 with no problem, before the layers of plastic film 1 start to be cut. The upper blade 3 is lowered at the relatively low speed V2 to come into contact with the lower blade 4. In the embodiment, the upper blade 3 comes into contact with the lower blade 4 when being decelerated at the maximum deceleration (5G) to the relatively low speed V2 (T2). Accordingly, the upper blade 3 does not bound due to an impact, making the layers of plastic film 1 cut appropriately. The upper and lower blades 3 and 4 are not damaged by the impact. The upper blade 3 is then lowered at the relatively low speed V2 until the layers of plastic film 1 start to be cut (T2 to T2′), keeping the lowered speed constant. In this way, the upper blade 3 comes into contact with the layers of plastic film 1 so that the layers of plastic film 1 can be cut by the upper and lower blades 3 and 4.

Furthermore, in the apparatus, the servomotor 5 is then accelerated again by the control means 14 to make the upper blade 3 accelerated again when the layers of plastic film 1 are being cut (T2′ to T5). The upper blade 3 is accelerated at an acceleration a 2 which is a relatively low acceleration (−1 G). Accordingly, the upper blade 3 is then lowered at a relatively high speed to make the layers of plastic film 1 cut by the upper and lower blades 3 and 4. In the embodiment, the servomotor 5 is accelerated again after a time from starting to be cut (T3). The speed then reaches a predetermined speed V3 after a time from being accelerated (T4). The speed is then maintained at the predetermined speed V3 until the completion of cut (T4 to T5).

It should therefore be understood that the apparatus is arranged to make the servomotor 5 accelerated and then decelerated so that the upper blade 3 can be lowered at the relatively low speed V2 and confine the time of low speed to a short time (T2 to T3). The servomotor 5 is then accelerated again so that the upper blade 3 can be lowered at the relatively high speed when the layers of plastic film 1 are being cut (T2′ to T5). The apparatus can therefore keep the cut speed from being lowered without taking time.

Furthermore, in the embodiment, the servomotor 5 is accelerated again to make the upper blade 3 accelerated again at the completion of cut (T5). The upper blade 3 is accelerated at an acceleration α3 which is the maximum acceleration (−5 G) and lowered at a speed which reaches a predetermined speed V4 after a time from the completion of cut (T6). The servomotor 5 is then decelerated by the control means 14 to be stopped. The upper blade 3 is therefore decelerated at a deceleration (β2) which is the maximum deceleration (5 G). The upper blade 3 is stopped at the lower limit LL.

The servomotor 5 is then reversed to make the upper blade 3 raised when the servomotor 5 and the upper blade 3 are stopped (T7). The servomotor 5 is accelerated by the control means 14 to make the upper blade 3 accelerated. The upper blade 3 is accelerated at an acceleration (α4) which is the maximum acceleration (5 G), to be raised at a speed which reaches the maximum speed (V5) after a time (T8). The upper blade 3 is raised at the maximum speed (V5) for a time (T8 to T9). The servomotor 5 is then decelerated by the control means 14 to be stopped. The upper blade 3 is therefore decelerated at a deceleration (β3) which is the maximum deceleration (−5 G). The upper blade 3 is stopped at the upper limit UL.

The servomotor 5 and the upper blade 3 are kept stopped for a time (T10 to T11). The upper blade 3 is then driven and lowered by the servomotor 5. The servomotor 5 is accelerated by the control means 14 to make the upper blade 3 accelerated. The apparatus then accomplishes the same cycle again so that the layers of plastic film 1 are cut again.

The apparatus can therefore keep the upper blade 3 from bounding due to an impact when coming into contact with the layers of plastic film 1, to make the layers of plastic film 1 cut appropriately. The upper and lower blades 3 and 4 are not damaged by the impact. In addition, the apparatus can keep the upper blade 3 from bounding due to an impact when coming into contact with the lower blade 4, to make the layers of plastic film cut appropriately. The upper and lower blades 3 and 4 are not damaged by the impact. Furthermore, the apparatus can keep the cut speed from being lowered without taking time so that the layers of plastic film 1 can be cut quickly. It is therefore practicable to remarkably speed up the apparatus.

In the apparatus, the servomotor 5 is accelerated and then decelerated by the control means 14 so that the upper blade 3 can be driven, lowered and raised to be changed in position P, as described earlier. The upper blade 3 is driven, lowered and raised along a predetermined positional characteristic curve which is input in the control means 14 with respect to the position P of upper blade 3.

By the way, an operator is in danger of his finger being nipped between the upper and lower blades 3 and 4 when the layers of plastic film 1 are cut by the upper and lower blades 3 and 4. The upper and lower blades 3 and 4 are subjected to a resistance when the finger is nipped so that a difference must occur between the real position of the upper blade 3 and the positional characteristic curve. In this connection, in the apparatus, the control means 14 is arranged to recognize if a difference occurs between the real position of the upper blade 3 and the positional characteristic curve in accordance with a signal transmitted from the servomotor 5 and make the servomotor 5 reversed or free of torque when the difference occurs. The control means 14 therefore constitutes a safety means to keep the operator from being seriously wound.

It is not always necessary that the servomotor 5 is accelerated again after a time from starting to be cut (T3) as described earlier. The servomotor 5 may be accelerated again simultaneously with starting to be cut. It is not always necessary that the servomotor 5 is accelerated again to make the upper blade 3 accelerated again at the completion of cut (T5) as described earlier. The upper blade 3 may be lowered at the predetermined speed V3 as shown by dotted line. In addition, it is not always necessary that the upper blade 3 is kept stopped at the upper limit UL for the time (T10 to T11) as described earlier. The upper blade 3 may be lowered once being stopped.

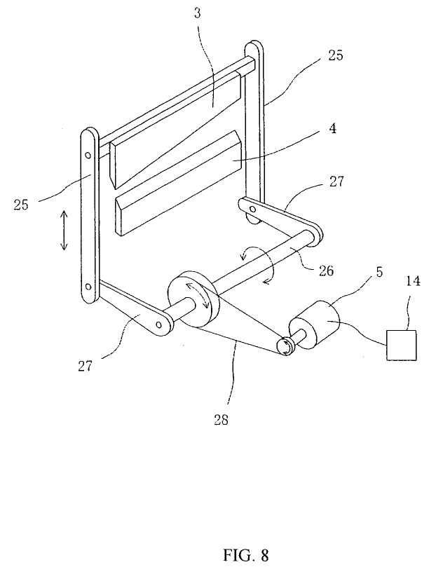

FIG. 8 illustrates another embodiment including a pair of bars 25 on which the upper blade 3 is mounted. A pair of levers 27 are fixed to a rotating shaft 26 and connected to the bars 25. The servomotor 5 is connected to the rotating shaft 26 by means of a chain or belt 28. It should therefore be noted that the servomotor 5 is connected to the bars 25 and upper blade 3. The rotational shaft 26 is rotated by the servomotor 5 and the chain or pulley 28 in one direction and the reverse direction to make the levers 27 swing along with the rotating shaft 26 so that the upper blade 3 and the bars 25 can be lowered and raised by the levers 27. The upper blade 3 can therefore be lowered and raised by the servomotor 5. The servomotor 5 is controlled by the control means 14 to be accelerated and decelerated, as in the case of the embodiment of FIG. 1.

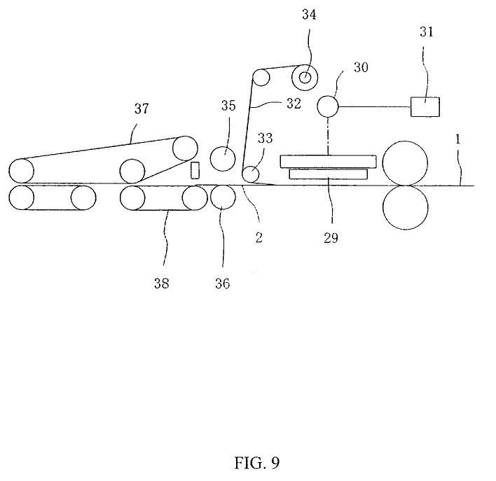

FIG. 9 illustrates an apparatus of a type disclosed in Japanese Laid-Open Patent Publication No. 2004-160780 in which the cutter includes a Thomson blade 29. The Thomson blade 29 has a shape corresponding to the shape of circumference of plastic bag 2. In addition, the apparatus includes drive means 30 comprising a servomotor and connected to the Thomson blade 29. For example, the servomotor 30 is connected to a crank mechanism connected to the Thomson blade 29. The apparatus further includes a control means 31 connected to the servomotor 30. The control means comprises a computer.

In the apparatus, plastic film means 1 is fed intermittently and longitudinally thereof, as disclosed in the publication. The plastic film means 1 comprises two superposed layers of plastic film which are heat sealed with each other by heat seal means whenever being fed intermittently. The Thomson blade 29 is driven and moved by the servomotor 30 and the crank mechanism to come into contact with the layers of plastic film 1 whenever the layers of plastic film 1 are fed intermittently. The Thomson blade 29 is pressed against the layers of plastic film 1. The layers of plastic film 1 are therefore cut by the Thomson blade 29 to successively plastic bags 2 with a waste 32 being kept continuous. The waste 32 is then guided by a guide roller 33 to be directed to and taken up by a taking up means 34. The plastic bags 2 are sandwiched between and fed by upper and lower rollers 35 and 36 to be disposed between and discharged from upper and lower belts 37 and 38.

In the apparatus of FIG. 9, the servomotor 30 is controlled to be accelerated and then decelerated by the control means 31 to make the layers of plastic film 1 cut. The Thomson blade 29 is therefore driven and moved at a relatively low speed to come into contact with the layers of plastic film 1 when the layers of plastic film 1 start to be cut. The layers of plastic film 1 are then cut by the Thomson blade 29. The layers of plastic film 1 can therefore be cut appropriately. The Thomson blade 29 is not damaged by an impact.

The servomotor 30 is then accelerated again so that the Thomson blade 29 can be driven and moved at a relatively high speed when the layers of plastic film 1 are been cut. The apparatus can therefore keep the cut speed from being lowered without taking time. The layers of plastic film 1 are cut quickly.

The Thomson blade 29 is driven and moved along a predetermined positional characteristic curve which is input in the control means 31, as in the case of the upper blade 3 of FIG. 1. In addition, the control means 31 is arranged to recognize if a difference occurs between the real position of the Thomson blade 29 and the positional characteristic curve in accordance with a signal transmitted from the servomotor 30 and make the servomotor 30 reversed or free of torque when the difference occurs. The control means 31 therefore constitute a safety means to keep the operator from being seriously wound.

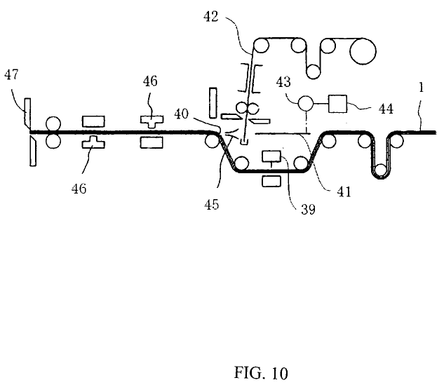

FIG. 10 illustrates an apparatus of a type disclosed in Japanese Laid-Open Patent Publication No. 2001-158056 in which the plastic bag comprises a flat bottom plastic bag including side gusset portions and a bottom gusset portion incorporated into two superposed layers of panel portion. In the apparatus, two superposed layers of plastic film 1 are fed intermittently and longitudinally thereof. The side gusset portions are formed between the layers of plastic film 1. In addition, the upper layer of plastic film 1 and the side gusset portions are cut by a cutter 39 to make an opening 40 formed therein whenever the layers of plastic film 1 are fed intermittently. The lower layer of plastic film 1 is not cut, as described in the publication.

Furthermore, the apparatus includes processing means comprising a spatula 41. The plastic film means comprises a sheet of plastic film 42 which is folded by the spatula 41. In addition, the apparatus includes drive means 43 comprising a servomotor and connected to the spatula 41. For example, the servomotor 43 is connected to a crank mechanism or feed screw connected to the spatula 41. The apparatus further includes control means 44 comprising a computer and connected to the servomotor 43.

In the apparatus, the spatula 41 is driven and moved by the servomotor 43 and the crank mechanism or feed screw to come into contact with the sheet of plastic film 42 whenever the layers of plastic film 1 are fed intermittently. The spatula 41 is moved longitudinally thereof to be pushed into a guide member 45 so that the sheet of plastic film 42 can be moved along with the spatula 41 and pushed into the guide member 45. The sheet of plastic film 42 is therefore folded by the spatula 41 and the guide member 45. In addition, the spatula 41 is inserted between the layers of plastic film 1 through the opening 40 so that the sheet of plastic film 42 can be inserted between the layers of plastic film 1 after being folded. The spatula 41 is then withdrawn from the sheet of plastic film 42 and returned to the original position.

The layers of plastic film 1 and the sheet of plastic film 42 are then heat sealed with each other by heat seal means 46 whenever the layers of plastic film 1 are fed intermittently. In addition, the layers of plastic film 1 are cut by a cutter 47 whenever being fed intermittently. The apparatus can therefore successively make plastic bags. The bottom gusset portion is formed from the sheet of plastic film 42 and incorporated into the layers of panel portion which are formed from the layers of plastic film 1.

In the apparatus of FIG. 10, the servomotor 43 is controlled to be accelerated and then decelerated by the control means 44 to make the sheet of plastic film 42 folded. The spatula 41 is therefore driven and moved at a relatively low speed to come into contact with the sheet of plastic film 42 when the sheet of plastic film 42 starts to be folded. The sheet of plastic film 42 is then folded by the spatula 41. The sheet of plastic film 42 can therefore be folded appropriately. The sheet of plastic film 42 and spatula 41 are not damaged by an impact.

The servomotor 43 is then accelerated again so that the spatula 41 can be driven and moved at a relatively high speed when the sheet of plastic film 42 is being folded. The apparatus can therefore keep the folded speed from being lowered without taking time. The sheet of plastic film 42 is folded quickly.

The spatula 41 is then driven and moved at the relatively high speed so that the sheet of plastic film 42 can be inserted between the layers of plastic film 1 after being folded. The sheet of plastic film 42 is therefore inserted quickly. The servomotor 43 may be decelerated again so that the spatula 41 can be driven and moved at a relatively low speed when the sheet of plastic film 42 starts to be inserted. In this case, the servomotor 43 should be accelerated again so that the spatula 41 can be driven and moved at a relatively high speed when the sheet of plastic film 42 is being inserted.

In the apparatus of FIG. 10, the spatula 41 is driven and moved along a predetermined characteristic curve which is input in the control means 44. In addition, the control means 44 is arranged to recognize if a difference occurs between the real position of the spatula 41 and the positional characteristic curve in accordance with a signal transmitted from the servomotor 43 and make the servomotor 43 reversed or free of torque when the difference occurs. The control means 44 therefore constitute a safety means to keep the operator from being seriously wound.

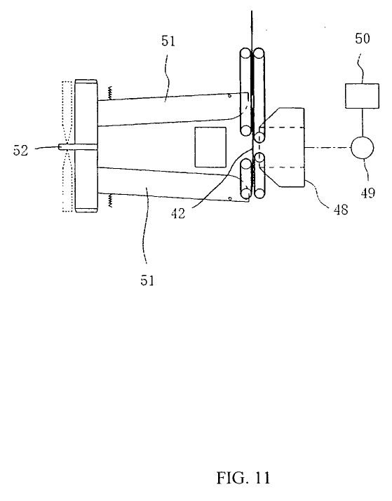

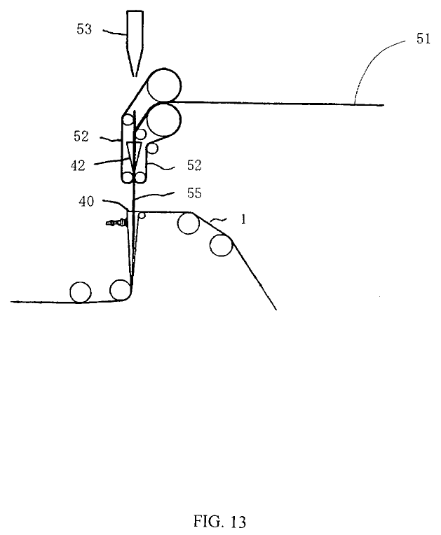

FIG. 11 illustrates an apparatus of a type disclosed in Japanese Laid-Open Patent Publication No. 2003-311853 in which the plastic bag comprises a flat bottom plastic bag including side gusset portions and a bottom gusset portion incorporated into two superposed layers of panel portion, as in the case of that disclosed in Japanese Laid-Open Patent Publication No. 2001-158056. In the apparatus, two superposed layers of plastic film 1 are fed intermittently and longitudinally thereof, as shown in FIG. 13. The side gusset portions are formed between the layers of plastic film 1. In addition, the upper layer of plastic film 1 and the side gusset portions are cut by a cutter to make an opening 40 formed therein whenever the layers of plastic film 1 are fed intermittently. The lower layer of plastic film 1 is not cut.

Furthermore, the apparatus includes processing means comprising a movable plate 48. The plastic film means comprises a sheet of plastic film 42 which is folded by the movable plate 48. The movable plate 48 comprises a trapezoidal or triangular double walled structure in which clearances are formed between the walls. In addition, the apparatus includes drive means 49 comprising a servomotor and connected to the movable plate 48. For example, the servomotor 49 is connected to a crank mechanism or feed screw connected to the movable plate 48. The apparatus further includes control means 50 comprising a computer and connected to the servomotor 49.

In the apparatus, the movable plate 48 is driven and moved by the servomotor 49 and the crank mechanism or feed screw to come into contact with the sheet of plastic film 42 whenever the layers of plastic film 1 are fed intermittently. The sheet of plastic film 42 is therefore moved along with the movable plate 48 after the movable plate 48 comes into contact. The movable plate 48 is moved in a direction of height of trapezoid or triangle. In addition, other plates 51 are engaged with the sheet of plastic film 42 and then inserted into the clearances on the opposite sides of the movable plate 48 widthwise thereof in accordance with the movement of the movable plate 48 so that the sheet of plastic film 42 can be folded by the movable plate 48 and other plates 51. The sheet of plastic film 42 is then sandwiched between, moved and held by a pair of belts 52 after being folded. The movable plate 48 is then returned to the original position. The sheet of plastic film 42 is stopped in position and kept downward to stand by.

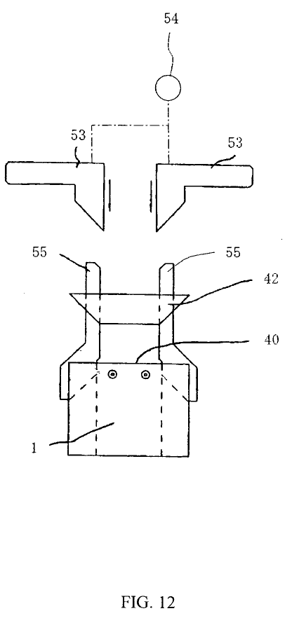

Furthermore, the apparatus includes processing means comprising finger means 53, as shown in FIG. 12. The finger means 53 comprises fingers by which the sheet of plastic film 42 is thrust after being folded. In addition, the apparatus includes drive means 54 comprising a servomotor and connected to the fingers 53. For example, the servomotor 54 is connected to a crank mechanism or feed screw connected to the fingers 53. The control means 50 is connected to the servomotor 54.

In addition, the opening 40 reaches a position corresponding to the sheet of plastic film 42 to be disposed and opened upward whenever the layers of plastic film 1 are fed intermittently. Guide plates 55 are then inserted into the side gusset portions of the layers of plastic film 1 and the folded portions of the sheet of plastic film 42. The fingers 53 are driven and moved by the servomotor 54 and the crank mechanism or feed screw to come into contact with the sheet of plastic film 42. The fingers 53 are inserted into the sheet of plastic film 42 to come into contact with the inner surface thereof. The sheet of plastic film 42 is therefore thrust by the fingers 53 to be inserted between the layers of plastic film 1. The fingers 53 are then withdrawn from the sheet of plastic film 42 and returned to the original position.

The layers of plastic film 1 and the sheet of plastic film 42 are then heat sealed with each other by heat seal means and cut by a cutter to successively make plastic bags, as in the case of the apparatus of Japanese Laid-Open Patent Publication No. 2001-158056. The bottom gusset portion is formed from the sheet of plastic film 42 and incorporated into the layers of panel portion which are formed from the layers of plastic film 1.

In the apparatus of FIG. 11, the servomotor 49 is controlled to be accelerated and then decelerated by the control means 50 to make the sheet of plastic film 42 folded. The movable plate 48 is therefore driven and moved at a relatively low speed to come into contact with the sheet of plastic film 42 when the sheet of plastic film 42 starts to be folded. The sheet of plastic film 42 is then folded by the movable plate 48. The sheet of plastic film 42 can therefore be folded appropriately. The sheet of plastic film 42 and the movable plate 48 are not damaged by an impact.

The servomotor 49 is then accelerated again so that the movable plate 48 can be driven and moved at a relatively high speed when the sheet of plastic film 42 is being folded. The apparatus can therefore keep the folded speed from being lowered without taking time. The sheet of plastic film 42 is folded quickly.

Furthermore, the servomotor 54 is controlled to be accelerated and then decelerated by the control means 50 to make the sheet of plastic film 42 inserted. The fingers 53 are therefore driven and moved at a relatively low speed to come into contact with the sheet of plastic film 42 when the sheet of plastic film 42 starts to be inserted. The sheet of plastic film 42 is then thrust by the fingers 53 to be inserted between the layers of plastic film 1. The sheet of plastic film 1 can therefore be thrust and inserted appropriately. The sheet of plastic film 42 and the fingers 53 are not damaged by an impact.

The servomotor 54 is then accelerated again so that the fingers 53 are driven and moved at a relatively high speed when the sheet of plastic film 42 is being inserted. The apparatus can therefore keep the inserted speed from being lowered without taking time. The sheet of plastic film 42 is inserted quickly.

In the apparatus of FIG. 11, the movable plate 48 and the fingers 53 are driven and moved along predetermined positional characteristic curves which are input in the control means 50. In addition, the control means 50 is arranged to recognize if a difference occurs between the real position of the movable plate 48, the real position of the fingers 53 and the positional characteristic curves in accordance with signals transmitted from the servomotors 49 and 54 and make the servomotor 49 or 54 reversed or free of torque when the difference occurs. The control means 50 therefore constitutes a safety means to keep the operator from being seriously wound.

1. An apparatus including processing means by which plastic film means is processed to successively make plastic bags, comprising:
drive means connected to the processing means so that the processing means can be driven and actuated by the drive means; and
control means connected to the drive means, the drive means being accelerated and then decelerated by the control means so that the processing means can be driven and actuated at a relatively low speed when the plastic film means starts to be processed, the drive means being then accelerated again by the control means so that the processing means can be driven and actuated at a relatively high speed when the plastic film means is being processed.

2. The apparatus as set forth in claim 1 wherein the drive means comprises a servomotor.

3. The apparatus as set forth in claim 1 wherein the processing means is driven and actuated along a predetermined positional characteristic curve.

4. The apparatus as set forth in claim 3 wherein the control means is arranged to recognize if a difference occurs between the real position of processing means and the positional characteristic curve in accordance with a signal transmitted from the servomotor and make the servomotor reversed or free of torque when the difference occurs.

5. The apparatus as set forth in any one of claims 1 to 4 wherein the processing means comprises a cutter by which the plastic film means is cut, the drive means being connected to the cutter, the plastic film means being fed intermittently and longitudinally thereof, the cutter being driven and actuated by the drive means so that the plastic film means can be cut progressively and widthwise thereof whenever being fed intermittently.

6. The apparatus as set forth in claim 5 wherein the cutter comprises a shear including upper and lower blades, the drive means being connected to the upper blade, the plastic film means being directed between the upper and lower blades, the upper blade being driven and lowered by the drive means to intersect with the lower blade and come into contact with the plastic film means whenever the plastic film means is fed intermittently so that the plastic film means can be cut by the upper and lower blades.

7. The apparatus as set forth in claim 6 wherein the upper blade is lowered at the relatively low speed to come into contact with the plastic film means when the plastic film means starts to be cut, the upper blade being then lowered at the relatively high speed when the plastic film means is being cut.

8. The apparatus as set forth in claim 7 wherein the upper blade is lowered at the relatively low speed to come into contact with the lower blade before the plastic film means starts to be cut, the upper blade being then lowered at the relatively low speed until the plastic film means starts to be cut.

9. The apparatus as set forth in any one of claims 1 to 4 wherein the processing means comprises a cutter including a Thomson blade, the drive means being connected to the Thomson blade, the plastic film means being fed intermittently and longitudinally thereof, the Thomson blade being driven and moved by the drive means whenever the plastic film means is fed intermittently so that the plastic film means can be cut by the Thomson blade.

10. The apparatus as set forth in any one of claims 1 to 4 wherein the plastic bag comprising a flat bottom plastic bag including side gusset portions and a bottom gusset portion incorporated into superposed two layers of panel portion, two superposed layers of plastic film being fed intermittently and longitudinally thereof, the plastic film means comprising a sheet of plastic film, the processing means comprising a spatula or movable plate by which the sheet of plastic film is folded, the drive means being connected to the spatula or movable plate, the spatula or movable plate being driven and moved by the drive means whenever the layers of plastic film are fed intermittently so that the spatula or movable plate can come into contact with the sheet of plastic film to make the sheet of plastic film folded, the sheet of plastic film being then inserted between the layers of plastic film, the plastic bag including the bottom gusset portion formed from the sheet of plastic film and incorporated into the layers of panel portion which are formed from the layers of plastic film.

11. The apparatus as set forth in any one of claims 1 to 4 wherein the plastic bag comprising a flat bottom plastic bag including side gusset portions and a bottom gusset portion incorporated into superposed two layers of panel portion, two superposed layers of plastic film being fed intermittently and longitudinally thereof, the plastic film means comprising a sheet of plastic film, the processing means comprising finger means by which the sheet of plastic film is thrust after being folded, the drive means being connected to the finger means, the finger means being driven and moved by the drive means whenever the layers of plastic film are fed intermittently so that the finger means can come into contact with the sheet of plastic film which is folded, the sheet of plastic film being thrust by the finger means to be inserted between the layers of plastic film, the plastic bag including the bottom gusset portion formed from the sheet of plastic film and incorporated into the layers of panel portion which are formed from the layers of plastic film.

12. An apparatus in which two superposed layers of plastic film are fed intermittently and longitudinally thereof, the layers of plastic film being cut progressively and widthwise thereof whenever being fed intermittently and after being heat sealed to successively make plastic bags, the apparatus comprising:
a servomotor connected to a cutter by which the layers of plastic film are cut; and
control means connected to the servomotor, the servomotor being accelerated and then decelerated by the control means so that the cutter can be driven and actuated at a relatively low speed when the layers of plastic film start to be cut, the servomotor being then accelerated again by the control means so that the cutter can be driven and actuated at a relatively high speed when the layers of plastic film are being cut.
